(19) United States
(12) Patent Application Publication
(10) Pub. No.: US 2004/0001748 A1
(43) Pub. Date: Jan. 1, 2004

(54) Compact dolly

(76) Inventor: David Landefeld, Pittsburgh, PA (US)

Correspondence Address: JAMES RAY & ASSOCIATES, 2640 PITCAIRN ROAD, MONROEVILLE, PA, 15146, US

(21) Appl. No.: 10/186,913

(22) Filed: Jun. 28, 2002

(51) Int. Cl. B62B 1/00

(52) U.S. Cl. 414/490

(57) ABSTRACT

A collapsible, wheeled dolly designed for enhanced portability and storage capabilities having at least one axle member, one frame member, a means for carrying a load and at least one wheel.

### FIELD OF THE INVENTION

The present invention generally relates to a dolly for transporting cargo. More particularly, the present invention relates to a portable dolly that collapses or disassembles into a container that may be strapped to a backpack, bicycle or just carried.

### BACKGROUND OF THE INVENTION

It is well known that carts or dollies are able to supplement human strength and endurance in transporting various types of heavy or ungainly loads over varied terrain. However, hikers, backpackers and hunters tend to encounter situations where they may be required to move heavier loads than are easily carried, such as downed game, camping supplies, firewood, fishing or hunting equipment and supplementary food. In order to accommodate their requirement to move such heavy or ungainly loads over terrain, it would be advantageous over portions of the trail to use a cart or dolly, terrain permitting. In such utilization, movement of the cargo on the cart or dolly would allow the user to transport the cargo easily. But, when rough terrain is encountered that does not permit the use of the cart, the cargo must be carried or dragged by the user and the cart becomes additional weight to carry or is left and returned for after the user has transversed the rough area. Carrying the cargo and the cart or dolly over rough terrain may not be easily accomplished or comfortable considering the size of the cargo transporting equipment or the portability of the cart or dolly.

It is also common that backpackers, hunters or hikers may not anticipate having to use a cart or dolly prior to beginning an excursion.

It should be noted that the foregoing background information is provided to assist the reader in understanding the instant invention. Accordingly, any terms of art used herein are not intended to be limited to any particular narrow interpretation unless specifically stated otherwise in this document.

### SUMMARY OF THE INVENTION

In one aspect, the invention generally features a collapsible wheeled dolly comprising at least one axle member engaged with at least one frame member, a means of carrying a load at least partially engageable with at least one frame member and, at least one wheel, rotatably engaged with the axle member or axle members. When assembled the wheeled dolly provides a framework supported by at least one wheel and enables transport of ungainly or heavy cargoes over some terrains.

### OBJECTS OF THE INVENTION

A primary object of the present invention is to provide a cart or dolly to transport heavy or ungainly materials or objects.

Another object of the present invention is to provide cart or dolly that is portable.

A further object of the present invention is to provide a portable cart or dolly that is compact and easily carried.

Yet another object of the present invention is to provide a portable cart or dolly that can be stored in a container adapted from components that make up the cart or dolly.

In addition to the objects and advantages of the present invention set forth above, various other objects and advantages will become more readily apparent to persons skilled in the art from a reading of the detailed description section of this document. Such other objects and advantages will become particularly apparent when the detailed description is considered in conjunction with the attached drawings and with the appended claims.

### BRIEF DESCRIPTION OF THE DRAWINGS

FIG. 1 is a perspective view of a presently preferred embodiment of the present invention.

FIG. 2 is a perspective view of a second embodiment of the present invention.

FIG. 3 is a top view of two wheels, as illustrated in FIG. 1, being used to form a storage compartment for a disassembled dolly wherein disassembled members of the portable dolly are shown.

FIG. 4 is a side view of two wheels, as illustrated in FIG. 1, being used to form a storage compartment for a disassembled dolly wherein disassembled members of the portable dolly are shown.

FIG. 5 is a sectional view of a disassembled component of an axle, a frame member or a cross-member in a preferred embodiment of the invention.

FIG. 6 is a sectional view of three interconnecting components as shown in FIG. 4, comprising a structural member of the dolly when assembled.

FIG. 7 is a perspective view of a third embodiment of the present invention.

### DETAILED DESCRIPTION OF THE INVENTION

Before describing the present invention in detail, for the sake and clarity of understanding, the reader is advised that identical components having identical functions in each of the accompanying drawings have been marked with the same reference numerals throughout each of the several Figures illustrated herein.

A cart or dolly capable of supplementing transportation of a cargo but small enough and light enough to unobtrusively fit on a backpack or over a shoulder would be an item backpackers, hunters or hikers would find extremely useful. In urban situations, it would be handy to have a compact cart or dolly stored away in a corner of the trunk of a car.

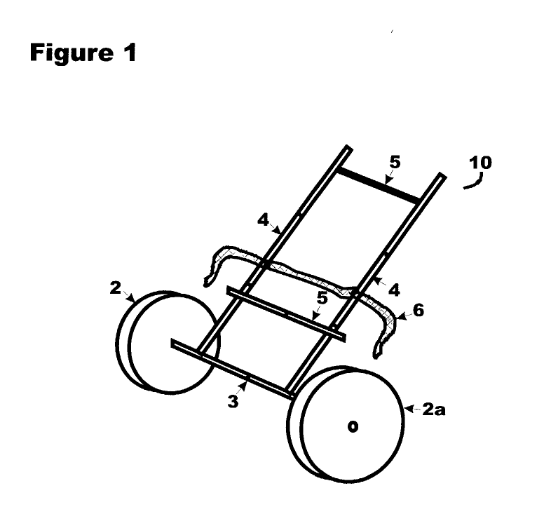

FIG. 1, depicting the preferred embodiment of the present invention, illustrates the assembled invention with two wheels 2 and 2a, rotatably engaged to opposing ends of an axle 3. Two frame members 4 are engaged with and extend outwardly from axle 3. Two cross-members 5 are shown attached at right angles to the frame members 4. Attached to frame members 4 is strap 6 for securing the intended cargo to the frame 4.

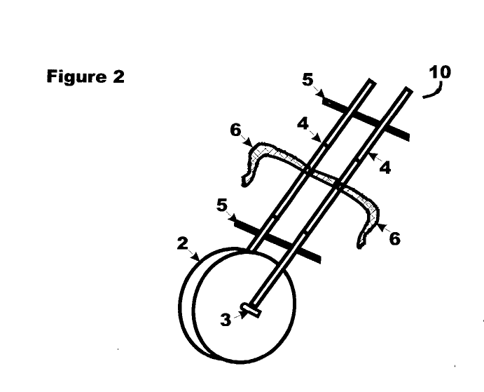

FIG. 2 illustrates another embodiment of the invention wherein only one wheel 2 is used. As in FIG. 1, two frame members 4 are engaged with and extend outwardly from axle 3 and two cross-members 5 are engaged with frame members 4.

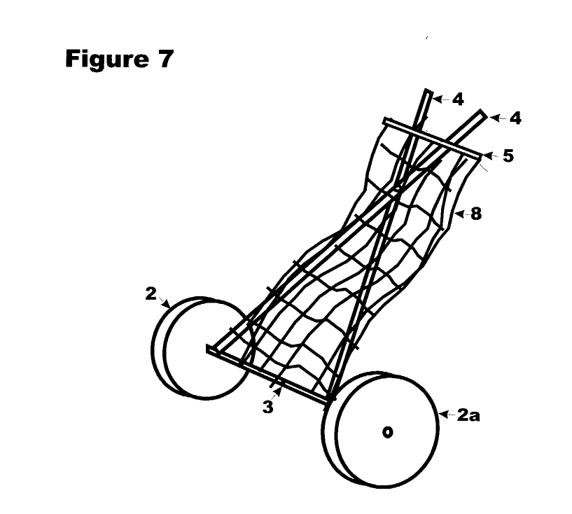

In embodiments illustrated in FIGS. 1, 2 and 7 included herein as well as other embodiments not illustrated herein, cross-member 5 is an embodiment of a means for carrying a load upon the assembled dolly. A means of carrying a load may be that two frame members are directly secured together, as in FIG. 7, the securing means being a bolt or pin that connects the two intersecting frame members to make the structure of the cart more rigid and supportive of loads that are carried. Generally, a cross-member intersects one or more frame members to make the dolly more stable.

Another means of carrying a load is to secure a net 8 to the dolly, as depicted in FIG. 7. The net 8 serves to hold an irregularly shaped load to the cart in order to facilitate movement of the cart.

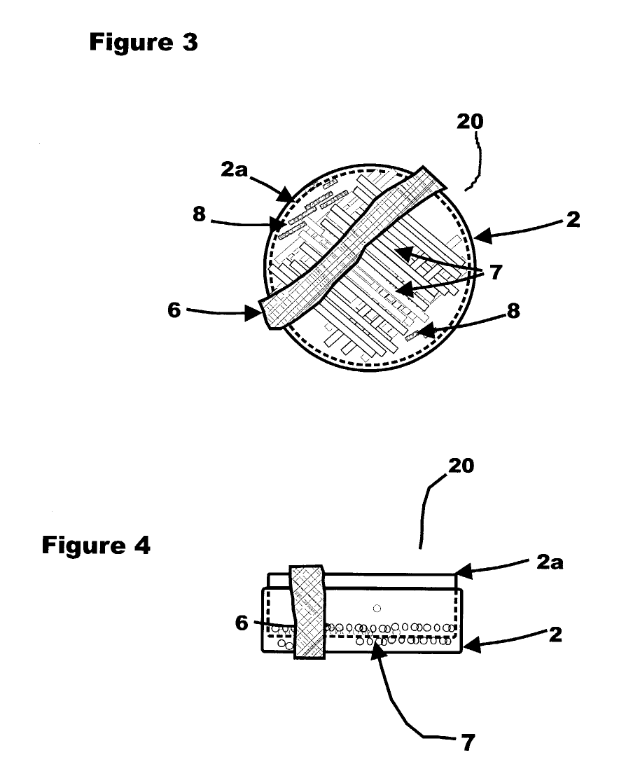

FIG. 3 depicts the wheels 2 and 2a fitted together to form a compartment 20 for storage. Each wheel 2 and 2a is open on one side to form a bowl-like configuration of a wheel with one side open. Wheel 2a fits inside wheel 2 with the open sides of wheel 2 and 2a facing. Each wheel 2 and 2a acts as a lid to complete the compartment 20. When the dolly is disassembled structural members 7 and threaded rods 8 are placed inside the compartment 20. Strap 6 may be used to provide a carrying strap for the storage compartment 20 or as a binding strap for compartment 20. Strap 6 may have a dual purpose with compartment 20 as a carrying and binding strap or strap 6 may be stored in compartment 20.

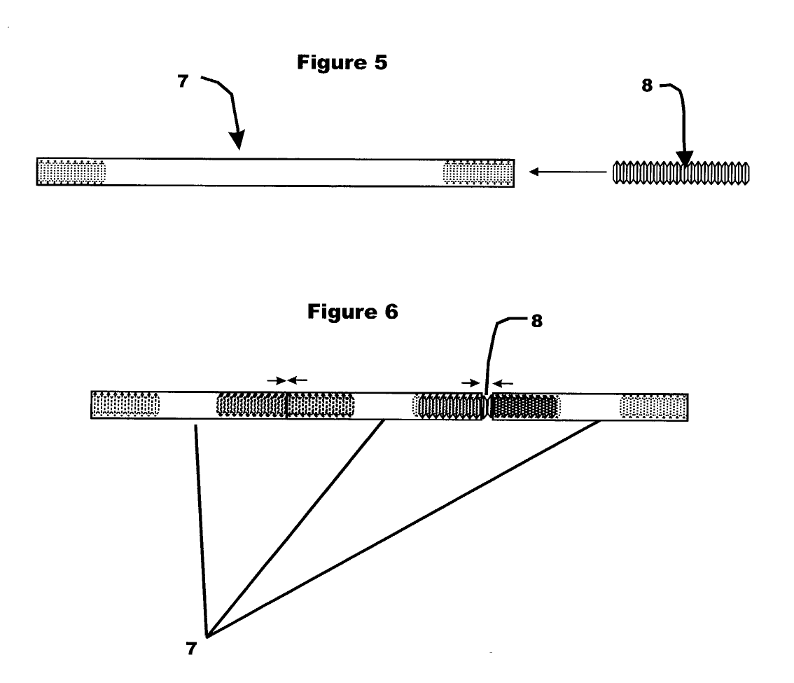

In FIGS. 1, 2 and 7, frame members 4, cross-members 5 and axle members 3 are constructed of interconnecting sections 7 that, when connected to a desired length, comprise respectively the frame members 4, the cross-members 5 and the axle member 3. The components of the frame 4, cross-member 5 and axle 3 are illustrated in FIG. 5 as a structural member 7.

FIG. 5 is a detail of a structural member 7 which is, combined with additional structural members 7 as required, comprising frame members 4, axle member 3 and cross-members 5 in the preferred embodiment of the present invention. Each structural member 7 is threaded internally to allow a correspondingly sized threaded rod 8 to be screwed into one or both ends of structural member 7. Each threaded rod 8 is screwed into the internally threaded portion of a second structural member 7 to bring the two structural members 7 together axially aligned. The process of end-to-end connection of structural member 7 is repeated as required to assemble each of the required frame members 4, cross-members 5 and axles 3 for a desired length. FIG. 6 illustrates three structural members 7 threadably connected with threaded rods 8 to form the basic structure of any one of the frame members 4, cross-members 5 or axle members 3.

When the frame members 4 and cross-members 5 are engaged to the axle 3 and the wheel 2 or wheels 2 and 2a are rotatably attached to the axle 3, the dolly 10 is ready for transporting suitably shaped and sized cargo. When dolly 10 is disassembled the structural members 7 and the threaded rods 8 are stored in the container 20 for transport or storage.

It can be seen from the above description that the present invention provides a collapsible wheeled dolly in a collapsed state, capable of compactly fitting into a container that is easily carried. More particularly, the container is created from at least one wheel that is hollow and, in conjunction with a lid or a second wheel used as a lid, provides a convenient container to store the parts of the dolly when not in use in the assembled state.

While the presently preferred embodiment of the collapsible wheeled dolly has been set forth in detail according to the Patent Act, those persons of ordinary skill in the technical art to which this invention pertains will recognize various alternative ways of practicing the invention without departing from the spirit and scope of the appended claims. Those of ordinary skill in the relevant art will also recognize that the foregoing description is merely illustrative and is not intended to limit any of the following claims to any particular narrow interpretation.

I claim:

1. A collapsible wheeled dolly, for enhancing portability and storage, said wheeled dolly comprising:
at least one axle member;
at least one frame member, engageable with and extending outwardly from said at least one axle member;
a means for supporting a load to be carried by said dolly at least partially engageable with said at least one frame member; and
at least one wheel, rotatably engageable with said at least one axle member.

2. A collapsible wheeled dolly, according to claim 1, wherein said means for supporting a load to be carried by said dolly is at least one cross-member, engageable with and extending outwardly from said at least one frame member.

3. A collapsible wheeled dolly, according to claim 2, wherein at least one of said at least one axle member, said at least one frame member and said at least one cross-member is collapsible by at least one of folding, telescoping, and interconnecting means.

4. A collapsible wheeled dolly, according to claim 2, wherein said at least one axle member, said at least one frame member and said at least one cross-member is formed from at least one of tubing, rods, and channel.

5. A collapsible wheeled dolly, according to claim 3, wherein said at least one axle member, said at least one frame member and said at least one cross-member is made from one of plastic, metal, fiberglass, wood and composite material.

6. A collapsible wheeled dolly, according to claim 5, wherein said at least one axle member, said at least one frame member and said at least one cross-member is formed of metal tubing.

7. A collapsible wheeled dolly, according to claim 2, wherein said means for supporting a load further includes a net, said net at least partially engageable with at least one of said at least one frame member and said at least one axle.

8. A collapsible wheeled dolly, according to claim 3, wherein said means for supporting a load further includes a net, said net at least partially engageable with at least one of said at least one cross-member and said at least one axle.

9. A collapsible wheeled dolly, according to claim 4, wherein said means for supporting a load further includes a net, said net at least partially engageable with at least one of said at least one frame member and said at least one cross-member.

10. A collapsible wheeled dolly, according to claim 1, wherein said at least one wheel is formed from one of high-density plastic, metal, wood, composite material and rubber.

11. A collapsible wheeled dolly, according to claim 10, wherein said at least one wheel is high-density plastic.

12. A collapsible wheeled dolly, according to claim 1, wherein said wheeled dolly further includes a portable container for storage of said wheeled dolly when collapsed.

13. A collapsible wheeled dolly, according to claim 12, wherein said portable container is formed from one of a tube, a box, a bag and said at least one wheel.

14. A collapsible wheeled dolly, according to claim 13, wherein said portable container is formed from said at least one wheel.

15. A collapsible wheeled dolly, according to claim 14, wherein said at least one wheel has an open side securable with a lid for closing said portable container formed from said at least one wheel.

16. A collapsible wheeled dolly, according to claim 15, wherein said wheeled dolly further includes two wheels wherein a second wheel serves as said lid.

17. A collapsible wheeled dolly, according to claim 1, wherein said wheeled dolly includes at least one adjustable strap.

18. A collapsible wheeled dolly, according to claim 17, wherein said at least one adjustable strap is used as a tie-down strap when carrying a load on said collapsible wheeled dolly.

19. A collapsible wheeled dolly, according to claim 17, wherein said at least one adjustable strap is a shoulder strap for carrying said portable container.

20. A collapsible wheeled dolly, according to claim 17, wherein said at least one adjustable strap is used for affixing said lid to said portable container.
